(19) United States
(12) Patent Application Publication
(10) Pub. No.: US 2001/0047310 A1
(43) Pub. Date: Nov. 29, 2001

(54) School commerce system and method

(76) Inventor: Randall A. Russell, Humble, TX (US)

Correspondence Address: GARY L. BUSH, MAYOR, DAY, CALDWELL & KEETON, L.L.P., SUITE 1900, 700 LOUISIANA, HOUSTON, TX, 77002, US

(21) Appl. No.: 09/819,133

(22) Filed: Mar. 27, 2001

Related U.S. Application Data
(60) Provisional application No. 60/192,724, filed on Mar. 27, 2000.

(51) Int. Cl. G06F 17/60

(52) U.S. Cl. 705/26

(57) ABSTRACT

The present invention is a method and apparatus for effectuating managed child, youth, young adult, or dependant commerce. The present invention conveniently allows parents, guardians or trustees to more effectively manage, control, and monitor the spending patterns of their dependants while simultaneously relieving the child of the burden of carrying and maintaining cash or checks. It also establishes a streamlined method for providers of goods and services to those dependants to be able to offer and provide those goods to children and for those sellers to receive payment for their services in a more effective manner than currently available. The present invention has specific functionality between parents, children, educational institutions, and goods and service providers. In a preferred embodiment, the apparatus of the present invention would include a central controller/trustee which manages funds provided by parents along with corresponding directives as to the manner in which the child may utilize the funds. The central controller/trustee has multiple functions, not only functioning as a vehicle for storing, managing and directing payment of funds for the child's purchases, but it also performs as a vehicle whereby information or notification regarding such purchases (either prospective or historical) may be interchanged between the sellers parents and the central controller/trustee in any combination thereof. The method and apparatus of the present invention have applications on the Internet as well as all other conventional communications systems.

### BACKGROUND OF THE INVENTION

1. Field of the Invention

The method and apparatus of the present invention relate to managed electronic fund payments and electronic communications using electronic networks.

2. Background

There exist a number of cash or near cash methods used for purchasing merchandise and services. The most common forms of payment are currency, checks, credit cards, and debit cards. To date though, children have very few payment options other than currency. If a youth or young adult chooses to make a purchase, they usually are limited to using only physical currency. This usually requires parents to fund their children's spending habits on a daily basis either with cash or checks. There are numerous and varied items children and young adults must purchase. The most common children's purchases relate to items needed in the ordinary course of their education. As the child grows older, the number and type of purchases usually increases proportionately.

To date, the only way a child can purchase items needed for his sustenance is through traditional means such as cash, checks, credit and debit cards. Those payment devices work well with adults but children have specific problems with those forms of payment. Children have an inherent lack of responsibility when managing money. Cash, being the most common form of payment by a child for his needs, is probably the least secure and hardest form of payment for the child to manage. The child must budget the allocated cash for all his daily needs, make payment in a system that he doesn't always understand, and maintain care and custody of the funds while they are in his possession to insure they are not lost or stolen. Cash is also especially burdensome for parents in that cash requires that the parent fund the child frequently, usually on a daily basis. Parents have to make numerous trips to the bank or ATM machine to fund their children's daily purchase needs.

Checks are another form of payment. Children, in funding their daily needs, use checks less often than cash. Checks are primarily used for one time specific types of purchases such as school pictures, dues, school book fines, uniforms and the like. Checks pose a problem as well for children. They are often lost in transit or forgotten to be turned in and even filled out improperly at times.

Credit cards and debit cards are another form of payment used by older, more responsible youths. Although the parent usually pays for the child's credit card purchases or funds the child's debit account, the parent has little or no control over the use of the credit card or funds once they are deposited to the account of the youth. It then becomes the youth's responsibility to budget and appropriate his funds and credit card purchases as he sees fit.

Prepaid programs are sometimes used by educational institutions. They are used primarily for funding school meals in the grade school and middle school levels. A parent is required to fund the child's meal account with a specified amount which usually lasts the child from as little as a few days to as much as a few months. Prepaid meal programs frequently are in use at the college level as well. The student pays for his “meal tickets” at the beginning of a semester and those “tickets” are used during the semester to purchase his meals.

Each of these funding methods have significant shortcomings. With all four methods of funding, the possibility of theft or loss of the funds is great. The day to day management of these types of payments is also very burdensome for the parents, children, institutions and vendors alike. Parents have to fund, children have to safeguard, and institutions and vendors have to collect, handle and account for purchases by children.

It is an overall object of the present invention to create a “managed method of commerce” that facilitates a safer and less cumbersome way for children and youths to fund their everyday needs.

Another object of the present invention is to create a more convenient payment form that youths can use as an alternative for making ALL their purchases.

Another object of the current invention is to provide a more uniform method of commerce for children.

Yet another object of the present invention is to give parents and guardians a method for funding their children's purchases on a basis other than “as needed” or “day to day”.

Another object of the present invention is to create an easier method for parents and guardians to fund their children by using electronic means.

Another object of the present invention is to provide a means whereby parents can manage and monitor their children's spending activities by allowing the parent to set daily spending limits and allow the parent to review records of their child's spending habits.

Another object of the present invention is to allow a parent to fund his child's purchases in a short period of time without the need for the parent to physically fund the child with cash, check, credit or debit card.

Yet another object of the present invention is to provide a managed communications portal that allows institutions and vendors to notify a parent of upcoming events and activities that pertain to their children which may require funding, also allowing the parent to fund that event or activity through the system.

Yet another object of the present invention is to allow institutions to send electronic notices to select groups of children (i.e. to seniors only, or to members of a certain club or organization).

Another object of the present invention is to provide a method whereby institutions and vendors may collect funds expediently for items sold to children without the need for handling cash or checks.

Another object of the present invention is to provide an accounting for institutions and vendors who sell products and services to children.

Yet another object of the present invention is to provide an accounting for childcare expenditures to parents.

Another object of the present invention is to create a trustee company to effectively aid in the management of transactions and communications between parents, children, institutions, and vendors.

### SUMMARY OF INVENTION

The present invention provides a method and apparatus for parents to effectively manage the monetary needs and spending patterns of their children, to simplify the parental funding process, to eliminate the need for children to have to carry cash and cash equivalents on their persons, and to streamline and expedite the monetary collection processes of institutions and vendors.

In one embodiment of this invention, communications between children as buyers and institutions and vendors as sellers are accomplished by means of an electronic network and a central controller. A parent wishing to establish an account for his child accesses the central controller located on a remote server. The parent furnishes the Trustee personal information as required to establish an account with the Trustee on behalf of the parent and child. The parent will furnish such information about himself and the child such as name, address, telephone number, social security numbers, school district and school the child attends, grade, and school affiliations.

At this point, the parent may direct the central controller to set any of a number of spending restrictions on the child. The parent may choose to set a daily or weekly spending limit or limit the child's spending for specific purchases such as school lunches only. The parent may also restrict the child's expenditures to specific institutions or vendors only. The parent may modify the child's restrictions at any time by contacting the central controller and resetting the restrictions as desired.

The parent then directs the Trustee as to the method for funding the account. The parent may fund the account by any number of funding methods including, but not limited to, cash, check, ACH debit, wire transfer, or credit card, debit card. The Trustee then funds the parent/child account as directed and takes custody of the funds. The child and the parent are now able to use the funds held by the Trustee for purchases.

When the child needs to make a purchase, he does so by entering his social security number and password into a keypad that is electronically connected to the central controller.

The controller then checks the child's account for fund availability and also checks for any parental controls or restrictions that may prevent the child from making the purchase. If the necessary funds are available and there are no parental controls or restrictions to prevent the child from making the purchase, then the purchase is allowed. Otherwise, that specific purchase is disallowed and the vendor is notified that the purchase cannot be made through the system.

If the purchase is allowed, an amount is debited to the child's account and credited to the account of the institution or vendor making the sale. At the end of each day, a transfer of funds is made to each institution and vendor's bank account in the amount of the total of their sales for each day for that vendor. An electronic record of both the purchase and sale are posted to the account of the buyer and seller essentially providing them with a physical accounting of all transactions to their accounts. Both buyer and seller may review their account history for any time period by contacting the controller through the Internet.

As a management function of the controller, the software periodically checks the parent/child account and reviews balances to determine if the account balance is low. If so, the software generates an electronic or paper message to the parent notifying him that it is time to replenish the account. Other management functions of the controller include, but are not limited to, analytical reviews of the account for detection of fraud and abuse, automatic replenishment of the parent/child account, item and inventory accounting, sales tracking, and systematic electronic downloading of data from the controller to institutions and vendors.

In another embodiment of the present invention, the system allows educational institutions to notify parents of upcoming events. Events may take the form of general school notices to notices that it is time for the parent to fund a particular event such as yearbooks or school pictures. In this embodiment, the system also allows the educational institution to target a specific group of students for a particular notification. For example, if the school wants to notify all seniors in high school that it is time to order and pay for caps and gowns, they my issue a memo and direct the controller to only send the notice to seniors eligible for graduation. The controller then selects the appropriate high school seniors who should receive the notice and then forwards the notice only to that specific group.

What the present invention accomplishes that no other invention before has done is to provide a common portal through which parents, children, educational institutions, and vendors may conveniently conduct a full range of business transactions between each other. These transactions are managed and made available through the central controller that manages all the functions necessary for youth commerce and two way communications between any of the aforementioned groups therefore creating a “clearinghouse” whereby business may be conducted.

The invention, by its nature, also allows for a mechanism of complete record keeping by all educational institutions through one common and convenient portal. Also, by its nature, it allows for the inclusion of Federal and State Governments as users. The Department of Education, for example, could use the portal for tracking such relevant data as school attendance and grade statistics that are frequently used for funding purposes. Therefore, all physical components of the educational system could be interconnected through one singular system, sharing information as needed.

It is a goal of the present invention to combine ALL of the components pertaining to child and youth commerce into one central managed system. The system provides a unique way for parents to manage, and children to fund all their spending needs as well as providing a unique way for institutions and vendors to receive payment for those items purchased by children. It also provides a unique portal through which information may be shared between all the components that relate to child care and child commerce.

### BRIEF DESCRIPTION OF THE DRAWINGS

FIG. 1 illustrates a simplified electronic embodiment of the invention.

FIG. 2 illustrates one embodiment of the central controller/trustee.

FIG. 3 illustrates one embodiment of the parent/child interface.

FIG. 4 illustrates one embodiment of the institution/vendor interface.

FIG. 5 illustrates an embodiment of how the parent establishes an account with the central controller/trustee.

FIG. 6 illustrates an embodiment of how the account established by the parent for the benefit of the child is funded.

FIG. 7 illustrates an embodiment of how an institution or vendor establishes an account with the central controller/trustee.

FIGS. 8, 9, and 10 illustrate an embodiment of how a child makes a purchase and shows an embodiment of the management functions of the central controller/trustee.

FIG. 11 illustrates an embodiment of how an institution notifies a specific body of students of an upcoming event that requires funding.

FIG. 12 illustrates an embodiment of how an institution maintains records on the controller trustee that may be accessed by state and federal agencies.

### DETAILED DESCRIPTION OF THE INVENTION

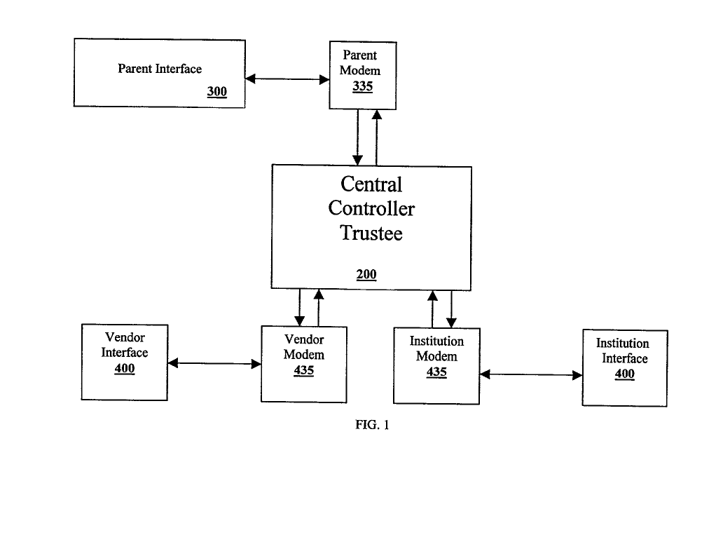

The method and apparatus of the current invention will now be explained with references to FIGS. 1, 2, 3, 4. In a preferred embodiment, the present invention will contain a central controller/trustee 200, a parent/child interface 300 and an institution/vendor interface 400. The present invention allows parents/guardians to establish a cash drawing account for the benefit of their children allowing the children to make purchases without the need to have physical cash or credit cards in hand. The present invention also allows the parent to direct the central controller/trustee to only allow purchases that are approved by the parent by enabling the parent to set restrictions on the spending limits and items that the child chooses to purchase. The present invention also allows institutions and vendors to conduct business with children without the burden of handling cash, checks, credit or debit cards. The invention also enables institutions and vendors to notify the parent of upcoming events that may need to be funded, allowing the parent to authorize payment for those goods and services. The invention also allows interactive communication and information sharing between the components of the commerce system by serving as an information portal between those authorized entities.

System Architecture

The system architecture of a first embodiment of the present invention is illustrated by referring to FIGS. 1 through 4. FIG. 1 shows the components of the present invention are comprised of a central controller/trustee 200, parent/child interface 300 and institution/vendor interface 400 (collectively referred to as the “components” of child commerce). Institutions, as defined herein, refer to banks, schools, day care centers, state, local and federal agencies. The components are interconnected with the central controller/trustee 200 by way of the Internet facilitated by the use of a switched phone network and by the use of the parent/child modem 335 and the institution/vendor modem 435. Connections may also be facilitated by any other means presently supported or as may be invented in the future.

Using the components mentioned above, the present invention facilitates the establishment of a managed system of child commerce and communication.

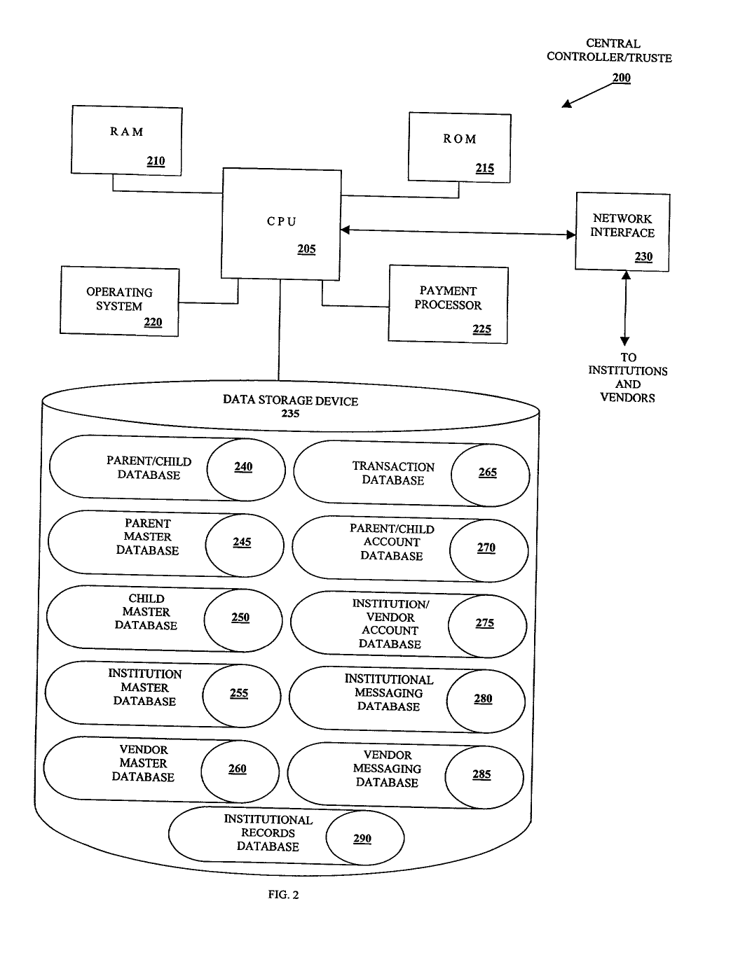

In one embodiment, the central controller/trustee 200, shown in FIG. 2, may consist of any type of computer mechanism suitable as a network server, capable of supporting numerous input and output transactions or mathematical computations. The central controller/trustee 200 operates as a web server connected to the Internet. The central controller/trustee 200 is composed of, but not limited to, the traditional hardware devices such as the CPU 205, RAM (random access memory) 210, ROM (read only memory) 215, data storage device 235 (such as a hard disk drive), and network interface 230 (such as a modem). A payment processor 235 may be used in conjunction with other hardware devices to expedite the payment processes or to facilitate the data storage function within the computer.

The central controller is also comprised of various operating system software 220 and database management software as needed to facilitate the maintenance of the various databases used in the present invention. These databases include the parent/child database 240, the parent master database 245, the child master database 250, the institution master database 255, the vendor master database 260, the transaction database 265, the parent/child account database 270, the institution/vendor account database 275, the institutional messaging database 280, the vendor messaging database 285, and the institutional records database 290.

The parent/child database 240 maintains data on the parents and students such as the parent and student's name and social security numbers. This database is used to “connect” students with parents and guardians. This database tells the controller which children “belong” to which parents or guardians. This database also facilitates connecting disjointed parents to the same account for children in common, thereby allowing separated or divorced parents to fund a common child's account. It also facilitates multiple guardians funding a single child's account.

The parent master database 245 maintains information on each parent or guardian that will be allowed to conduct business on behalf of the child. The database contains information on each parent such as name, social security number, address, telephone numbers, email address, primary method of funding child's account, and credit card information or bank drafting information (if necessary). It also contains the social security numbers of each child that has an account that the parent will be responsible for.

The child/master database 250 contains information on each child, such as the child's name, address, social security number, date of birth, school district, school, current grade level, daily spending limits, type items the child may purchase, minimum account replenishment level balance needed before notification of parent. It also contains the social security numbers of the parents authorized to fund the child's account.

The institution master database 255 maintains data regarding institutions such as the institution's name, address, telephone number, contact person's name, contact person's number, country, state, school district name, school, banking institution, bank account name, and bank account number. In the case of non-school institutions, the institution master database will contain such information as the local, state or federal government with which affiliated, agency name, agency phone number and agency contact person's name.

The vendor master database 260 contains information on the vendor and will contain information such as the vendor's name, address, address, phone number, contact person, contact person's phone number, vendor's bank name, vendor's bank account name, and vendor's bank account number.

The transaction database 265 will contain a record of all monetary transactions recorded through the central controller/trustee 200 including child account number, selling institution/vendor number, item purchased, amount of purchase, date and timestamp of purchase.

The parent/child account database 270 contains records of all the monetary transactions for the parent/child account. It contains a record of each transaction of deposits and disbursements for the account.

The institution/vendor account database 275 contains records of all the monetary transactions for the institution or vendor's account. It contains a record of each institution's or vendor's sale of goods and services and corresponding daily amounts credited to the institution or vendor's bank account.

The institutional messaging database 280 contains a record of all the messages that a particular institution has sent, or intends to send, to students or parents.

The vendor messaging database 285 contains a record of all the messages that a particular vendor has sent, or intends to send, to students or parents.

The institutional records database 290, maintains records on the institution and the attending students such as student enrollment, student attendance, students state and federal test scores and census information. This information is used by the institution for record keeping purposes and can also be accessed by authorized local, federal and state agencies for purposes of grading, funding and census information gathering.

Network interface 230 is used as the communications portal connection between parents, children, institutions and vendors through the central controller/trustee 200. The network interface will support any type of electronic communications based information. In a preferred embodiment, the network interface is connected to the Internet or through any one or through any combination of Online Service Providers or Internet Service Providers.

While FIG. 2 shows the central controller/trustee 200 to be one device, in another embodiment the central controller/trustee 200 may be composed of multiple devices, similar in nature, in different locations all connected through a LAN or WAN network. This embodiment would provide for multiple “servers” capabilities eliminating server and wire traffic bottlenecks. A multiple central controller/trustee 200 device embodiment would serve in providing backup systems in case of server or communication system hardware or software failure as well.

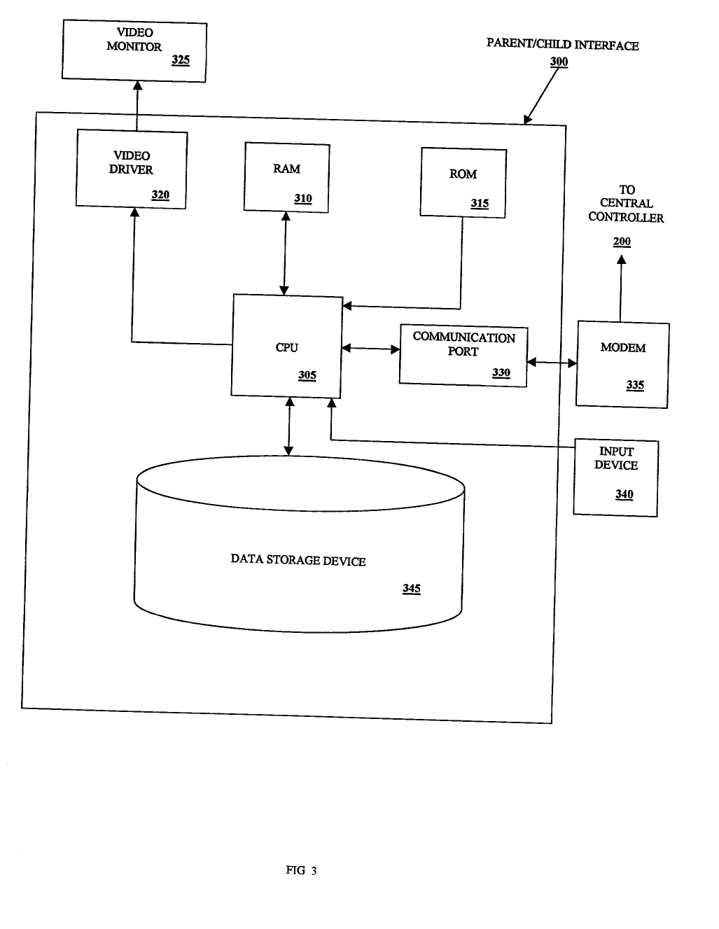

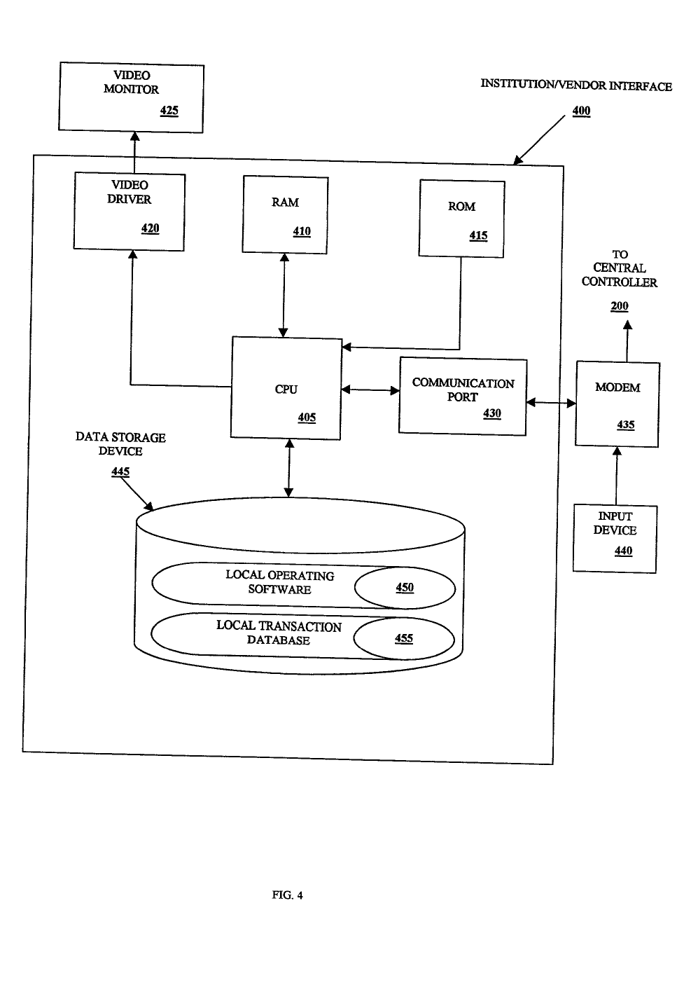

FIGS. 3 and 4 show typical parent/child interface 300 and institution/vendor interface 400 respectively. In one embodiment of the current invention, these interfaces are essentially typical personal computers connected to the Internet via modem device having input and output capabilities. The input would typically be done on a keyboard device and the output would typically be done typically through a display device such as a monitor, with both devices connected to the personal computer. These devices allow the user to interconnect with the central controller/trustee 200 and relay information to and receive information from the controller.

As shown in FIG. 3, a typical personal computer which may be used as the parent/child interface would be comprised of a central processor 305, RAM 310, ROM 315, video driver 320, video monitor 325, communication port 330, modem 335, input device 340 and data storage device 345.

As shown in FIG. 4, a typical personal computer which may be used as the institution/vendor interface would be comprised of a central processor 405, RAM 410, ROM 415, video driver 420, video monitor 425, communication port 430, modem 435, input device 440 and data storage device 445, local operating software 450 and local transaction database 455. The local operating software 450 and local transaction database 455 are used in an alternate embodiment of the present invention as a “local” software and database system that records and stores the transactions as they occur and transfers the data at a later time to the central controller/trustee 200 all at once, rather than on a transaction basis. This embodiment provides an alternate means to conduct business if the central controller/trustee 200 is overburdened at specific times or is inoperable for any reason.

In another embodiment of the present invention, a keypad modem device such as those used for credit card reading is used as the interface for institutions and vendors. This device would typically, but not necessarily, be connected to a cash register allowing automatic input and output from the cash register device to the central controller/trustee 200. This device can be used as a substitute for the personal computer as an input device especially at “point of sale” locations within institutions and vendor outlets speeding the sales recording transaction time and allowing seamless integration of sales with institution and vendor software.

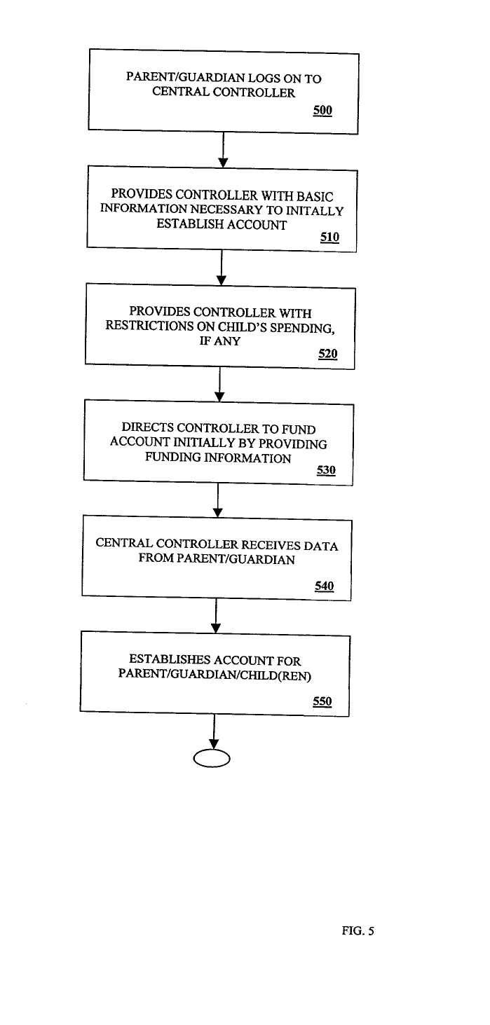

In a preferred embodiment of the present invention, electronic networks facilitate all communication between the various users of the system. The central controller/trustee 200 would be configured as a web server providing worldwide access to the system. In FIG. 5, 500 a parent or guardian logs on to the central controller/trustee 200 and provides the central controller/trustee 200 with pertinent information to establish an account for his child 510. The system prompts the parent for a secret password at this point to be used later in the transaction processes as a security precaution.

The parent also makes the decision at this point whether to establish one account for all his children or establish an account for each child. If the parent establishes one account for all children, he is able to fund the one account rather than having to spread the funding between all the children. The parent then informs the central controller/trustee 200 of any spending restrictions he may want to impose upon each child 520. The parent may wish to impose a daily spending limit upon the child. For example, the parent may want only to allow the child to spend $3.50 per day from the account, enough to purchase the child's lunch at school. Additional limits may be imposed upon the child as well. The parent may wish further to restrict the child's spending to only a specified institution(s) or vendor(s). Many other restriction limits may be imposed upon the child by the parent that may be changed at any time simply by logging on to the system and resetting the restrictions.

The parent then directs the central controller/trustee 200 as to how he wants to fund the account by providing credit card, debit card, checking account drafting instructions, or some other means of funding such as a check or cash sent directly to the managing trustee company 530. The central controller/trustee 200 then receives all the account data input by the parent 540. The central controller/trustee 200 then establishes the account for the child 550. The child's account is now ready to be funded.

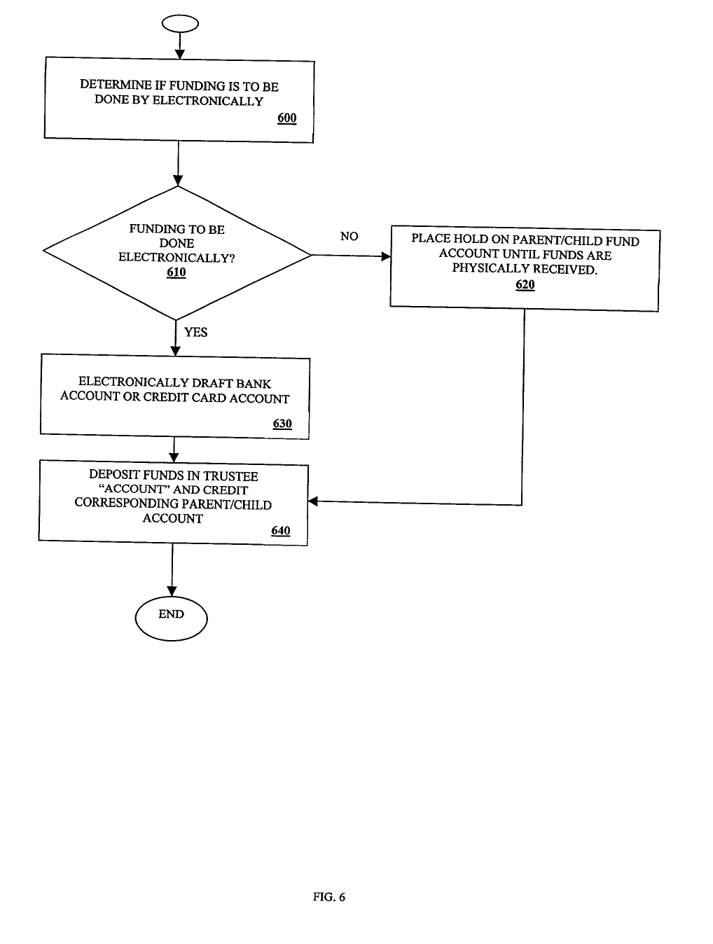

Referring to FIG. 6, the central controller/trustee 200 then determines whether the funding is to be done electronically by analyzing the method of funding specified by the parent 600. If the funding is to be done electronically 610, the central controller then drafts the bank account, debit account, or credit card account specified by the parent 630. If funding is not to be achieved by electronic means, then a hold is placed upon the child's account until the Trustee Company physically receives the funds 620. The funds are then deposited into a specified bank account held by the managing trustee company that is only used for payments on behalf of children and youths. After receipt of funds from the parent, the child's electronic account is then credited for the amount deposited by the parent and is ready for use 640.

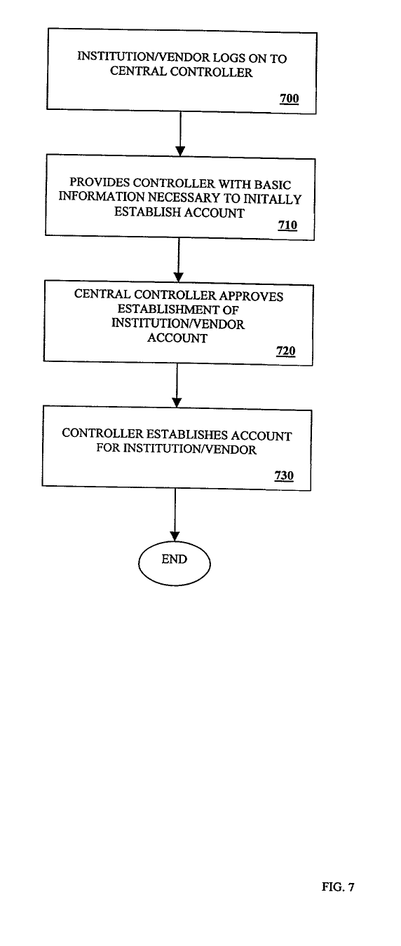

Institutions and vendors also must register to be providers of goods and services under the system. FIG. 7 illustrates how a typical vendor would log onto the central controller/trustee 200 to establish an account 700. The institution/vendor then provides the central controller/trustee 200 with pertinent information regarding the provider 710. After approval as a provider under the system 720, the provider is assigned an account by the central controller/trustee (200) 730. The institution/vendor is then able to conduct business with children by using the system.

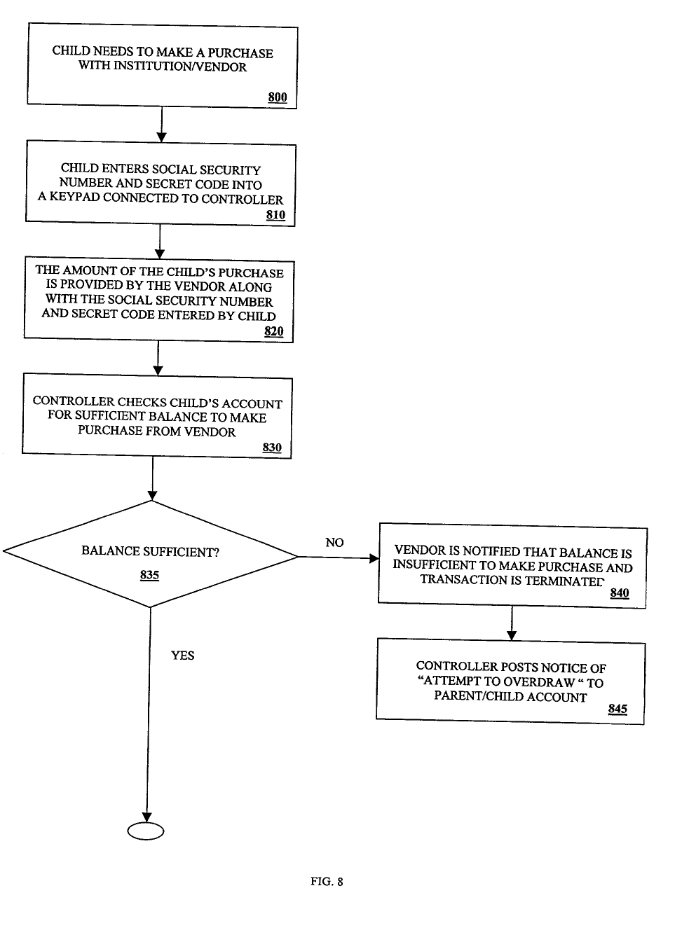

FIG. 8 illustrates how a typical transaction would occur between a child and an institution. In one embodiment of the present invention, when the child needs to make a purchase with an institution or vendor 800, the child would make his purchase selection then enter his social security number and secret code into a keypad 810. The child's social security number, secret code and purchase amount are then transmitted to the central controller/trustee for approval 820. The central controller/trustee 200 accepts the data and finds the child's account number from the child master database 250. The central controller/trustee then checks the child's account for sufficient funds to make the purchase 830.

If the balance in the child's account is not sufficient 835, the vendor is notified that the transaction is not approved and the transaction is terminated 840. The central controller/trustee 200 then posts a notice to the child's account that an attempt to overdraw the account occurred 845. The parent will then be able to see the attempted transaction at any time he reviews the account. This message is a flag to the parent that something may be out of order with the child's account.

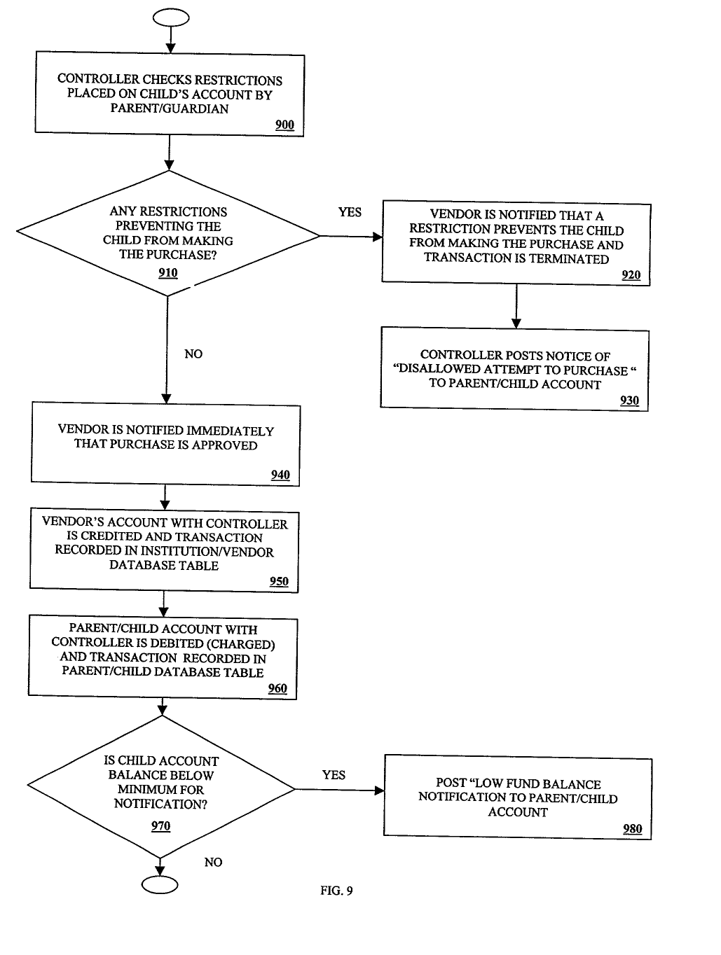

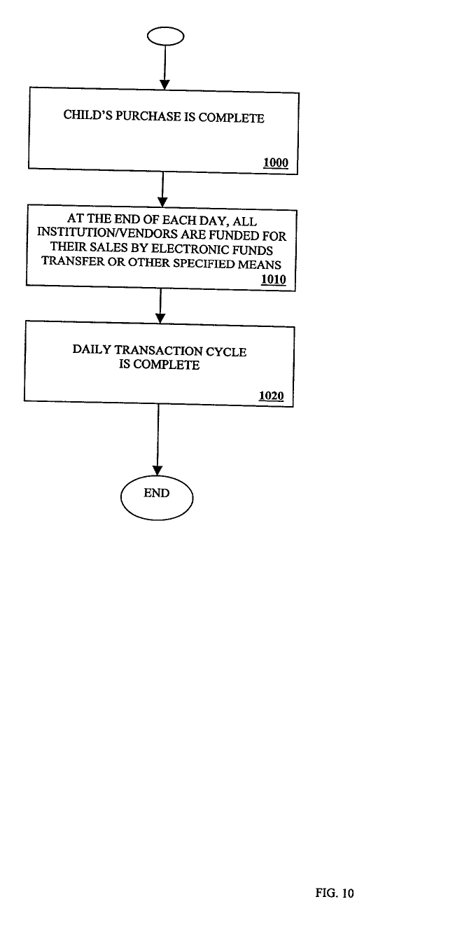

Referring to FIG. 9, if the balance in the child's account is sufficient 835, then the controller proceeds to check the child master database 250 for any restrictions placed upon the account by the parent/guardian 900. The central controller/trustee 200 then makes the determination if any of the restrictions would prevent the child from making the purchase 910. If there are restrictions preventing the child from making the purchase, the vendor is notified that the transaction is not approved and the transaction is terminated 920. The central controller/trustee 200 then posts a notice to the child's account that a disallowed attempt to purchase has occurred 930.

If no restrictions prevent the child from making the purchase 910, then the vendor is notified that the purchase is approved 940. The institution or vendor's account with the central controller/trustee 200 is now credited and the child's account is now debited in the amount of the transaction 960. The central controller makes an additional check after the child account is debited to see if the balance in the child account is below a minimum specified by the parent for notification 970. If the amount is less than the minimum notification amount, a notice is generated to the child's parent that the account needs replenishment soon 980. The notice generated may be in the form of electronic mail (e-mail), by written notice sent by common mail carrier, by posting a notification to the child's account, or even in the form of a telephone call. If the amount in the child's account is not below the minimum needed for notification, then the child's purchase is complete 1000.

At the end of each day, the daily amounts credited to each institution or vendor are totaled by the central controller/trustee 200 and an amount equaling the days sales is paid to the institution or vendor by electronic funds transfer or some other means specified by the institution or vendor 1010. The daily transaction cycle is now complete 1020.

The system is versatile in that not only does it allow child and youth funding and spending transactions it also allows institutions to notify parents of upcoming events that may need funding. This notification ability serves to inform the parent of upcoming events or activities that may need funding. When the parent receives the notification, the parent may choose to fund the activity himself from the account rather than having to entrust the child to do the funding. This is just one of many additional management functions provided by the system.

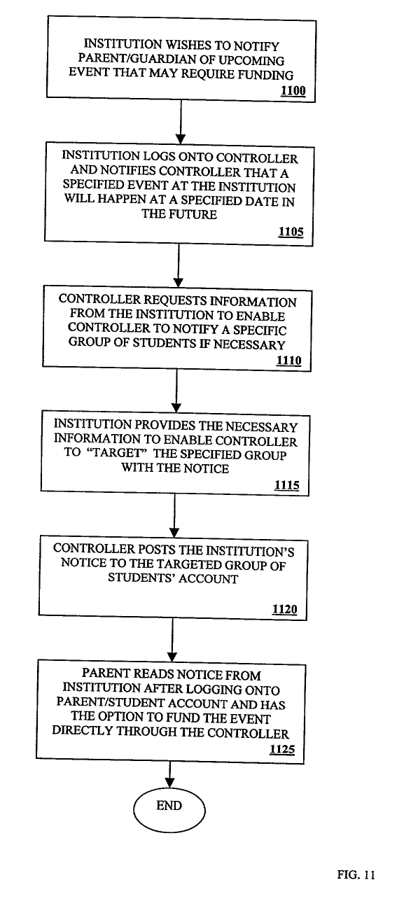

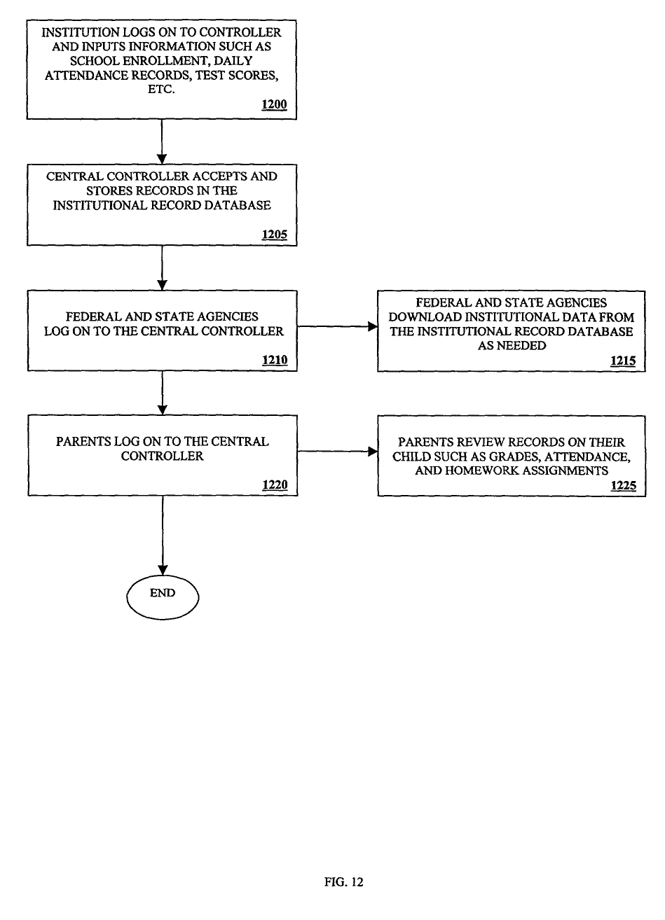

Referring to FIG. 11, an institution wishes to notify the parent of an upcoming event that may need to be funded by the parent or child 1100. An example of a notification would be a notice by the institution that school pictures are forthcoming on a specific date and that the parent has the option of ordering online from the child's account. The institution logs onto the central controller/trustee 200 and notifies the controller that a specified event sponsored by the institution will happen on a specified date in the future 1105. The central controller/trustee 200 requests specific information from the institution which enables the central controller/trustee 200 to notify the group of children the institution wants to notify 1110. The institution provides the information necessary to “target” the specified group of children 1115. An example of a target group would be notification by the institution to all freshmen that school pictures are going to be taken on a specified date in the future. By providing the central controller/trustee 200 with the grade classification of the “target” group, the central controller/trustee 200 can search the directory of all students accounts who are enrolled at the institution that are freshmen and send the notification to that target group only. The central controller/trustee 200 then posts the institution's notice to each of the targeted group's account by either posting a notice directly to the account or by an e-mail or other specified means of notification 1120. The parent then reads the notice from the institution and has the option to fund the event directly through the central controller/trustee (200) 1125.

In another embodiment of the current invention, the institution may use the central controller/trustee 200 as a data warehouse. The institution can store information within the central controller/trustee 200, such as daily school enrollment, attendance records, or state test scores, to name a few. The institution would log onto the central controller/trustee 200 and input the information directly into the central controller/trustee 200 by manual or automated electronic file uploading 1200. The central controller/trustee 200 would then accept and store the uploaded records from the institution 1205 into the institutional record database 290. This database would be used for storing data that the institution wishes to archive for use by themselves or for use by other authorized entities or government agencies.

Should the data be required for use by a government agency, the federal, state or local agency logs on to the central controller/trustee (200) 1210 and downloads the necessary data from a particular institution or all institutions at once 1215. The central controller/trustee 200 can be used as a source for all information that needs to be shared by institutions and federal, state and local government agencies.

As an additional byproduct of institutions recording such data within the central controller/trustee 200, parents can have access to specific allowed data about their children. An example of institutional data parents may use would be information about their child's attendance records, test scores and grades. The parent would log onto the central controller/trustee (200) 1220 and be able to review their child's institutional records or even homework assignments via the Internet 1225.

There are many variations and applications in the method and apparatus of the present invention. The scope of the present invention is not limited to only the representative examples disclosed herein but also covers conventionally known variations and modifications to the system components described herein as well.

What is claimed is:

1. A school commerce system comprising
an electronic network based central controller trustee computer which is accessible by students, parents, school trustees, and vendors via an electronic network, said central controller trustee computer including software having,
a commerce database module by which a parent has previously established a student account with pertinent information about the student and with information as to how the account is to be funded from a third party financial institution by said parent and with information as to spending restrictions with a vendor which are imposed on said account by said parent,
means for transferring funds from said third party financial institution into said student account, and
means for transferring funds from said student account to a vendor account when said student inputs a unique identifier and password and indicates a desired purchase from said vendor.

2. The school commerce system of claim 1 wherein said student account may optionally be a common student account for a plurality of students of a parent.

3. The school commerce system of claim 1 further comprising
means for verifying that there are no restrictions on said student account that would prohibit a transaction with said vendor.

4. The school commerce system of claim 1 further comprising
means for monitoring said student account to determine if a minimum balance is present in said account, and
means for notifying said parent if said minimum balance is not present in said student account.

5. The school commerce system of claim 1 further comprising
means for determining a balance and transaction history in said student account, and
means for a parent to have electronic access to said balance and said transaction history in said student account.

6. The school commerce system of claim 1 further comprising
means for monitoring said student account for abnormal student account activity, and
means for notifying said parent of said abnormal student account activity.

7. The school commerce system of claim 1 further comprising
means for transferring funds from said vendor account to a third party vendor financial institution.

8. The school commerce system of claim 1 further comprising
means for determining a vendor account balance and transaction history in said vendor account, and
means for said vendor to have electronic access to said vendor account balance and transaction history.

9. The school commerce system of claim 1 further comprising
means for notifying a parent of said student who has a student account of information about school events of interest.

10. The school commerce system of claim 1 further comprising
means for selecting student accounts for notification of said school events and notifying a parent based on said information retrieved from said database module.

11. The school commerce system of claim 1 further comprising
an information database including data associated with each school of a plurality of schools in a school district.

12. The school commerce system of claim 11 further comprising
means by which a trustee of a particular school has access to information in said information database about said particular school.

13. The school commerce system of claim 11 further comprising
means for school trustees to input information in said information database.

14. The school commerce system of claim 11 further comprising
a governmental agency database, including information established by a governmental agency about said governmental agency, and
means for said governmental agency to access information in said information database and said governmental agency database.
